(19) United States
(12) Patent Application Publication
(10) Pub. No.: US 2003/0172030 A1
(43) Pub. Date: Sep. 11, 2003

(54) Payee match positive pay banking

(75) Inventor: Alexander A. Volgunin, Superior, CO (US)

Correspondence Address: MERCHANT & GOULD PC, P.O. BOX 2903, MINNEAPOLIS, MN, 55402-0903, US

(73) Assignee: Parascript, LLC

(21) Appl. No.: 10/093,180

(22) Filed: Mar. 6, 2002

(51) Int. Cl. G06F 17/60

(52) U.S. Cl. 705/42

(57) ABSTRACT

An issued check is verified in a computer-implemented positive-pay bank check processing system. A scanned check amount, a scanned bank account number, and a scanned check number are read from a scanned image of the issued check. A payee name field on the scanned image of the issued check is located, and a scanned payee name is read from the payee name field. Based on the bank account number and the check number, a record payee name or names are retrieved from an issued check file listing checks issued by a payer or owner of the checking account on which the issued check is drawn. A payee name field on the scanned image of the issued check is located, and a scanned payee name is separated from other information in payee name field, such as payee address. The scanned payee name is matched against a lexicon of record payee name variations based on the record payee name or names. Also, standard noise payee names are added to the lexicon to create a competition with the payee name from check issued file. The payee name on the check is verified if the similarity between the scanned payee name and a payee name from the lexicon indicates a high confidence match. If the payee name is verified, the issued check is authenticated as a positive pay check. If the scanned check amount is compared to the record check amount, and the check amount may also be verified when the scanned check amount and the record check amounts are the same.

### FIELD OF THE INVENTION

This invention relates to the matching of payee name in a positive pay banking process. More particularly, the invention relates to extracting the payee name from check images and verifying the payee name before allocating funds and processing the bank check at the bank.

### BACKGROUND OF THE INVENTION

Commercial customers of banks when generating business checks have a practice of also generating a issued check file that may be forwarded to the bank upon which the check is drawn. When the check is subsequently deposited for payment at the bank, data on the check such as the account number, the check number and the amount of the check may be cross checked or verified against a scanned image of the check versus the same data in the issued check file. This banking process is referred to as positive pay meaning that the payment of the check by the bank is validated against check data received from the issuer of the check.

To date, there has been no automated process for also verifying the payee name on the check. Accordingly, even though the positive pay process allows the bank to check the amount, the account and the check number it was possible for the bank customer and the bank to be defrauded by a person altering the payee name on the check.

Because of the variability in business or commercial checks, it is difficult to process payee name from the scanned image of the check. Thus, to date, payee name has not been a part of the positive pay check validation process.

### SUMMARY OF THE INVENTION

In accordance with this invention, the above and other problems have been solved by locating the payee name field of the check, extracting the information in the payee name field, separating the name out of the information in the payee name field and authenticating the payee name against the payee name in the check issued file. Further, the operation of locating the payee name field identifies the style or format of the check. Once the format of the check being processed is identified then the payee field in a check image can be located for the purpose of extracting payee information from the field. As a further feature of the invention, the payee information includes the extraction of payee name from the payee field, which usually includes the payee name and the address of the payee. Once the payee name image is separated from the address information, then the payee name is verified by matching the payee name image against all variations on the payee name(s) for the same check in the issued check file received from the issuer of the check.

As a bank check processing system, the present invention authenticates an issued check before disbursing funds according to an amount on the issued check to a payee named on the issued check. In this system, a payee name verify module verifies the payee named on the issued check against a lexicon of payee names for the same check in the issued check file. A disburse module, and in response to verification of the payee named by the payee name verify module, disburses funds to the payee named if both verifications are successful.

Amount verification can be added to the above bank check processing system. In such a system, an amount compare module verifies the amount on the issued check against an amount for the same check in an issued check file received by the bank from the issuer of the check. The disburse module, in response to verification of the payee named by the payee name verify module and in response to verification of the amount by the amount compare module, disburses funds to the payee named if both verifications are successful.

As a method for positive pay verification of issued checks, the method first locates a payee name field on the issued check. A payee name is parsed from the payee name field to generate an issued check payee name. The method also gets from an issued check file, which lists checks issued by a payer of the issued check, a stored or record payee name for the issued check. The positive pay verifying of the issued check is accomplished by matching the issued check payee name or names against a lexicon of variations on the record payee name or names and by verifying the issued check payee name when there is a high confidence match between the issued check payee name and a payee name variation in the lexicon. If the issued check payee name is verified, the method indicates the issued check is a positive pay check.

In addition, the amount of funds in the issued check may be verified. A scanned amount is read from a scanned image of the issued check and a check amount is retrieved from the issued check file. Then an act of comparing a scanned amount read from the issued check against the check amount from the issued check file will indicate the scanned amount is verified if the scanned amount read from the issued check and the check amount from the issued check file match.

These and various other features as well as advantages, which characterize the present invention, will be apparent from a reading of the following detailed description and a review of the associated drawings.

### BRIEF DESCRIPTION OF THE DRAWINGS

FIG. 1A is an overview of one embodiment of the invention illustrating the operational flow to perform the positive pay payee matching operations.

FIG. 1B illustrates an exemplary computing system environment in which the various embodiments of the invention may be implemented.

FIG. 2 illustrates a computing environment in which the various embodiments of the invention may operate.

FIG. 3 is an illustration of an exemplary check that may be verified in accordance with various embodiments of the present invention.

FIG. 4 illustrates one embodiment the operational flow for locating the payee field.

FIG. 5 illustrates one embodiment for separating the payee name from the address in the payee information field.

FIG. 6 shows one embodiment of the operational flow for matching the payee name from the scanned image against the payee name in the issued check file to verify the payee name.

### DETAILED DESCRIPTION OF THE PREFERRED EMBODIMENTS

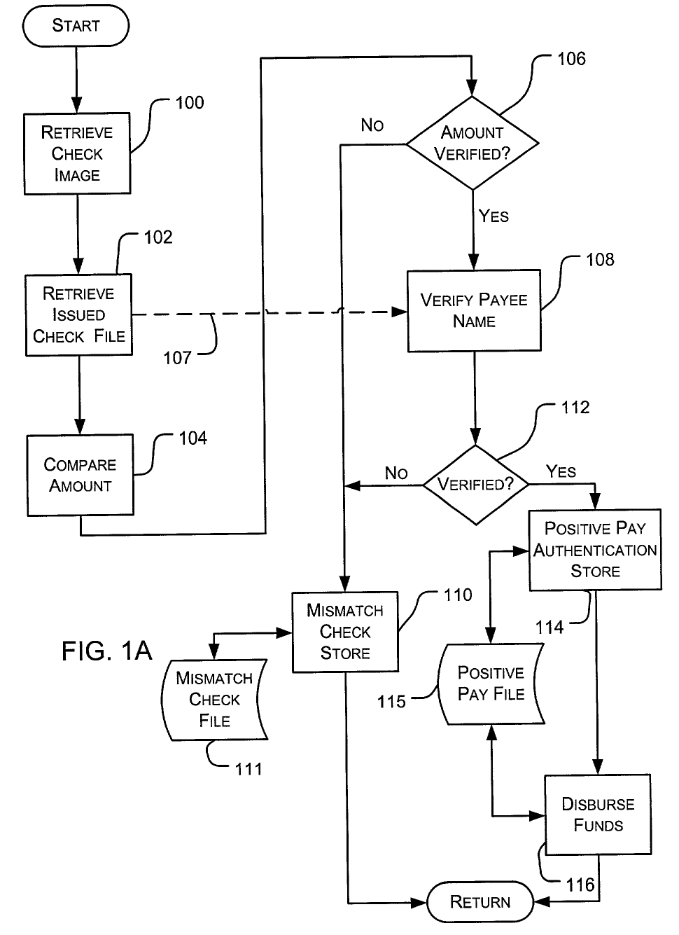

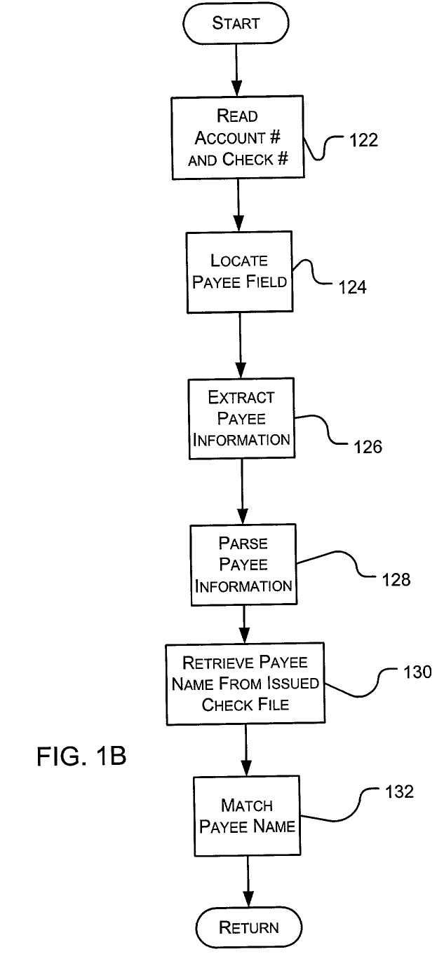

In FIG. 1A, one embodiment for processing the checks for payee match and positive pay verification is illustrated. The operational flow begins with check image retrieve operation 100 pulling up the check image previously scanned into the bank check processing system. The scanned check image will of course contain a complete image of the check and as such contain a scanned image of an amount of funds, a payee name, a check account number and a check number. As is well known, the check account number and check number might be separately scanned by magnetic or optical character recognition techniques separated from processing the complete scanned check image. Issued check retrieve operation 102 gets the issued checks file electronically sent to bank by the bank account owner (the payer of the check). The issued check file will contain check records indicating the account number, the check number, the check amount and the check payee name. Based on the account number and the check number, i.e. a check identifier, both the check image and the issued check record or information are retrieved and passed to the verify amount operation 104.

The verify amount operation 104 will match or compare a scanned amount, it reads from the check image, with a check, or record, amount for that account number and check number for the check record in the issued check file. If the amount of funds verifies, verify test operation 106 will pass the operation flow on to verify positive pay verification operation 108. If the verify amount operation is not successful, verify test operation will branch the operation flow NO to mismatch check store operation 110. In operation 110, the check is identified as a mismatch, and the check identification by account number and check number is sent to and stored in a mismatch check file 111. Subsequently, checks listed in this mismatch file may be manually examined. Checks that have successfully passed the verify amount operation 104 as detected by verify test operation 106 are then machine examined to verify the payee name in payee name verification operation 108.

In another embodiment of the invention, there is no amount verification operation. When there is no amount verification, the operation flow proceeds directly from retrieve issued check file operation 102 along path 107 (shown as dashed line) to payee name verification operation 108. Of course, if amount verification is desired, another alternative embodiment would be to perform amount verification after the payee name verification.

In payee name verification operation 108 the payee name is located, extracted from the check image and is validated against a check, or record, payee name for the check in the issued check file based on the corresponding account number and check identification number in the issued check file. The pay name verification operations are described hereinafter with reference to FIG. 1B.

If the payee name verification operation 108 was not successful as detected by test operation 112, the operation flow branches NO to mismatch check store operation 110. Store operation 110 identifies the check by account number and check number and lists the check in the mismatch check file 111. If the payee name verification is successful, the payee verified test operation 112 branches the operational flow YES to positive pay authenticate and store operation 114. Based on the payee name being verified, operation 114 identifies the check as authenticated. Operation 114 also stores the check by account number and check number as an authenticated check in the positive pay file 115 which may also be referred to as a matched check file. In disburse operation 116, the bank check processing system examines the positive pay or matched check file 115 and disburse funds electronically to the payee for the positive pay verified checks listed in file 115. This disbursement operation may be performed on-line as checks are listed in the positive pay file, or it may be performed off-line later as batch processing of the checks listed in positive pay file.

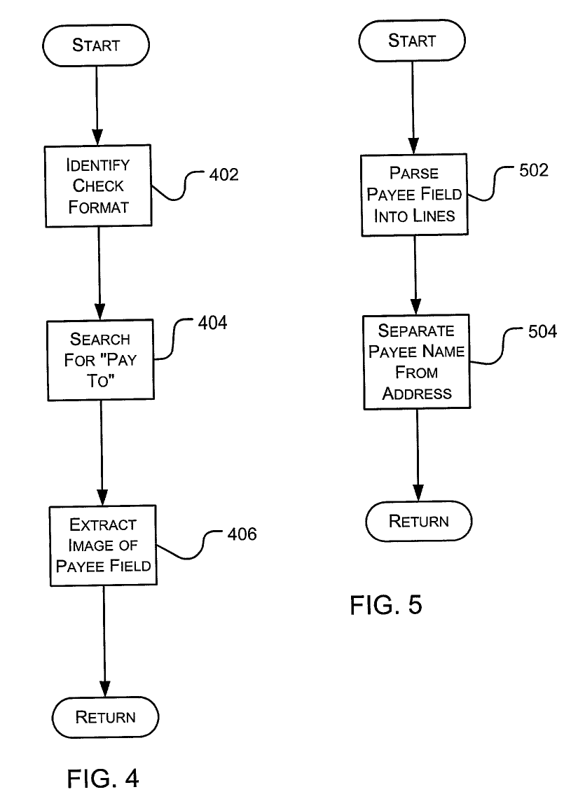

In FIG. 1B, one preferred embodiment for the verify payee name operation 108 in FIG. 1A is illustrated. The verify payee name operation flow begins with read operation 122 retrieving or getting from the check image the account number. With the account number of the check identified, the locate payee field operation 124 retrieves a check format for the check and searches for the payee field in a defined location based on check format. This defined location will be either immediately below or immediately to the right of the phrase “pay to the order of” which appears on all checks. One embodiment of the locate operation is described hereinafter with reference to FIG. 4.

Once the payee field location is found, the extract operation 126 examines the image data in the payee field to interpret the payee information. The payee information typically includes the payee name plus address information. Often in business checks this payee information in the payee field is located at a position for visibility through an envelope window for mailing the check out to the payee. Thus, the extraction of payee information is simply the first stage of processing of the payee field image for verification. With the payee information extracted from the payee field, the first part of the verification of that payee information is to parse the information so as to separate out the payee name from the payee address. This may be accomplished in a number of ways, some of which are illustrated in FIG. 5. However accomplished, the output of the parse operation 128 is the payee name image processed in preparation for verification against the payee name and the check issued file.

Retrieve payee name operation 130 gets the check payee name, i.e. the record, or stored, payee name or names, from the check record in the issued check file for the check having the same account number and check number, i.e. check identifier, as the check in the check image. The match payee name operation 132 precedes to read the scanned payee name image and compare the scanned payee name against all variations of stored payee name or names for the same check in the issued check file to produce a similarity value. The similarity value is a measure of confidence that the payee name in the scanned image matches on the payee name(s) on the issued check from the check file. Accordingly, the output of the match operation 132 is a list of possible payee name matches with associated similarity or confidence values.

The verification test operation 112 (FIG. 1A) receives this list and tests for successful payee name verification. The test includes two criteria. First, is the similarity or confidence value of the name with the highest value above a certain threshold. Second, is the difference in similarity value between the payee name at the top of the list with the highest value and the payee name with the second highest value greater than a second threshold. If both of these criteria are satisfied, then the scanned payee name match with the stored payee name on the check from the issued check file is indicated as successful, i.e. payee name is verified.

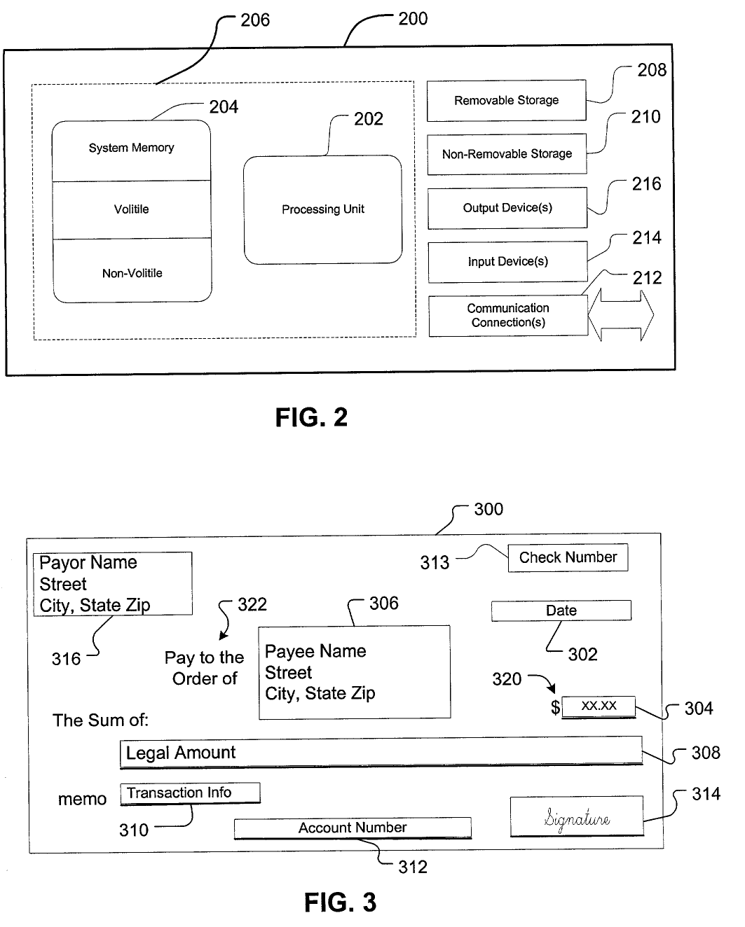

FIG. 2 illustrates an example of a suitable computing system environment 200 on which the invention may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or palm-sized devices, tablet devices, laptop devices, multiprocessor systems, microprocessor-based systems, set top boxes, programmable consumer electronics, network PCs, minicomputers, mainframe computers, distributed computing environments that include any of the above systems or devices, and the like.

In its most basic configuration, computing device 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, device 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210.

Memory 204, removable storage 208 and non-removable storage 210 are all examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 200. Any such computer storage media may be part of device 200.

Device 200 may also contain communications connection(s) 212 that allow the device to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media or computer program product as used herein includes both storage media and communication media.

Device 200 may also have input device(s) 214 such as keyboard, mouse, pen, voice input device, touch screen input device, check scanners etc. Output device(s) 216 such as a display, speakers, printer, electro-mechanical devices, such as check handlers, controlled by device 200, may also be included. All these devices are well know in the art and need not be discussed at length here. The particular input/output device working with the computing device 200 will depend on the application in which the recognition system is working and whether the recognition is system is working offline or online with cursive images being recognized.

FIG. 3 shows a check 300 having information fields that contain text and may be positive pay verified in accordance with embodiments of the present invention. Although the check 300 being verified may be any form of a negotiable instrument, the check 300 is shown in FIG. 3 as a personal or business check. As described in FIG. 4, the check 300 has a limited number of styles or formats so as to facilitate the automated extraction of the payee field.

Check 300 includes a date information field 302, a numerical pay amount information field 304 often referred to as the courtesy amount field, a payee information field 306, an alphanumeric pay amount information field 308 often referred to as the legal amount field, a memo/category information field 310, an account number information field 312, a check number information field 313 a signature information field 314 and a payer information field 316. The payer is the owner of the bank account and the party issuing or drafting the check. The payee information field 306 and the payer information field 316 contain the names and addresses of the payee and payer respectively. In this exemplary business check these fields are located where they would be visible through windows in a mailing envelope. Check 300 illustrates one format for the check; the bank would normally provide multiple styles of checks from which the bank customer could choose. The style or format of the check once chosen will be associated with the customer account so that the locations of fields on the check will be known to the automated check processing equipment.

The payee name information field 306 may be located directly adjacent to a text block 322 containing the phrase ‘Pay to the Order Of,’ as shown in FIG. 3. The text block 322 may be positioned adjacent to the payee name information field 306 such that the printed payee name completes the phrase “Pay to the Order Of.”

By arranging the payee name information field 306 in this manner, a check processing procedure, such as the procedure described in FIG. 4, below, may locate payee name information written or printed on the check 300 by locating the position of the payee field 306. Alternatively, such a check processing procedure may find the printed payee field by locating the position of the text block 322 and finding the payee information adjacent to the text block 322. Likewise, the memo category text may be found by such a procedure by locating the memo information field 310 or by locating the text “memo”, which, as shown in FIG. 3, is preferably printed adjacent to the memo category information field 310.

With the computing environment in mind (See FIG. 2), the logical operations of the various embodiments of the present invention are implemented (1) as a sequence of computer implemented steps running on a computing system and/or (2) as interconnected machine logic modules within the computing system. The implementation is a matter of choice dependent on the performance requirements of the computing system implementing the invention. Accordingly, the logical operations making up the embodiments of the present invention described herein are referred to variously as operations, steps or modules. It will be recognized by one skilled in the art that these operations, steps and modules may be implemented in software, in firmware, in special purpose digital logic, and any combination thereof without deviating from the spirit and scope of the present invention as recited within the claims attached hereto.

FIG. 4 illustrates one preferred embodiment of the operational flow for locating the payee field and extracting the image of the payee field. The locate operational flow begins with the identify operation 402 identifying the check format. In one embodiment, the check format is identified by matching the check image against a predetermined set of check format or check style images. In this embodiment the bank would specify for example, ten check types, styles or formats that the customer may select from. These check types will have a format that places the amount field, the payee name field at specific locations on the check. A library of check type images would be stored and then the check image under evaluation would be in turn compared against the check images in the library. Once the scanned check image matches a library check image the check type or format will be identified.

In another embodiment of the invention, the check type might be specified by the information for the account. For example, an account number might have predefined check format associated with it. In this situation, the identify check format would simply read the account number and indicate the associated check format with that account number.

Once the check format has been identified by identify operation 402, the check format is passed to search operation 404. Search operation 404 based on the identified check format of the scanned check image will then search for the phrase “pay to the order of” in an area of the check where the check format indicates the pay to phrase should appear. This may be accomplished for example by shifting the scanned check image against a reference “pay to the order of” phrase in a digital image until there is a correlation or match between the scanned image and the reference image. When the phrase pay to the order of is matched, the location of the phrase will have been found.

Thereafter, extract operation 406 can extract the payee field image. The payee field image will be defined as a predetermined area on the check according to the check format. Usually, this payee field is immediately to the right or immediately below, or a combination of both, relative to the phrase pay to the order of. After the payee field image is extracted the operational flow returns to the parse payee information operation 128 in FIG. 1B which is the next operation.

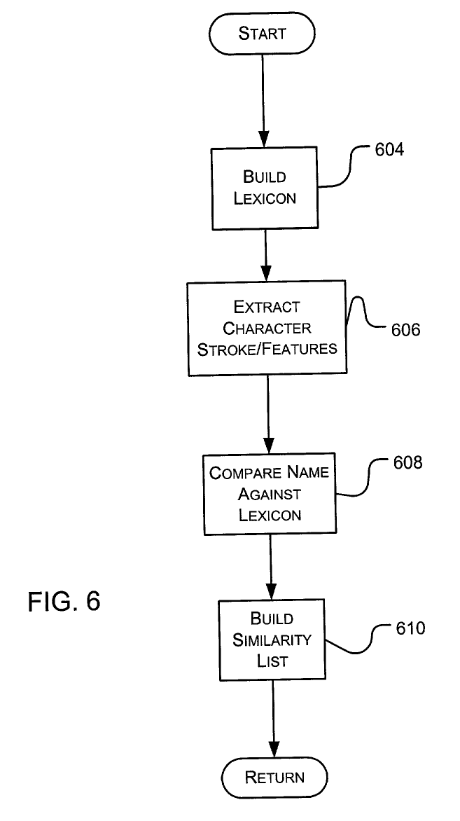

FIG. 5 shows the operational flow of one embodiment for parsing the image of the payee field into a payee name image and an address image. The parse operation 502 first parses the payee field image into lines. The result of this parse into lines is a textual image for each line. Separation operation 504 then separates the payee name from the address. This may be accomplished in any number of ways. In one embodiment, the top most line parsed from the payee field image can be assumed to be the payee name and the top most line will be examined as the payee name. In another embodiment of the invention, each of the lines will be examined for address formatting. Typical address formatting would include numeric characters either in the street address line or in the city and state address line. These lines containing typical address characteristics would be eliminated as choices for the payee name. A remaining line, if any, would then be identified as the payee name text line. In yet another embodiment of the separation operation, the simplest technique would be to prioritize each of the lines as a possible payee line and then attempt to match in the matching operation 132 (FIG. 1B) each of the text lines in the payee name field. The payee name information parsed by parse operation 130 as just described in detail above with reference to FIG. 5 is then passed to the match payee name operation 132 (FIG. 1B). FIG. 6 illustrates one embodiment of this match operation.

In FIG. 6, the payee name match operation operational flow begins with build lexicon operation 604. Build lexicon operation 604 receives from retrieve operation 130 (FIG. 1B) the check payee name or names from the check record in the issued check file for the check having the same account number and check number as the check in the scanned check image. Build lexicon operation stores the payee name or names in a lexicon or vocabulary and commences to create variations on the payee name or names. These variations may include variations in characters, they may include common typographical error variations and in short basically create variations on the payee name that might be looked upon as noise relative to the exact payee name image. Also, standard noise payee names are added to the lexicon to create a competition with the payee name from check issued file.

Once the lexicon or vocabulary of the payee name variations is built, character feature extraction operation 606 commences to parse the scanned payee name image into sub-images. Depending on the matching or reading technique used, the sub-images might be individual characters in the payee name, or they might be strokes within characters, sometimes referred to as metastrokes. With the character features extracted, the compare name operation 608 begins to recognize or match the payee name against the lexicon of payee name variations. The matching technique in the preferred embodiment is that described in the U.S. Pat. No. 5,313,527, issued to Guberman et al and entitled Method And Apparatus For Recognizing Cursive Writing From Sequential Input Information. However, there are numerous other character or word recognition or matching techniques that could be used. Some examples would be character by character image overlay, stroke overlay, or strings of characters or word overlays of image of entire payee name. In the Guberman technique, the entire payee name would be matched to produce a combined similarity value for all strokes or metastrokes within the payee name. This similarity value is an indicator of confidence that the payee name in the check image matches the payee name in the check from the issued check file.

The scanned payee name is compared against all payee name variations in the payee name lexicon. A similarity value will be produced for each of these variations in the lexicon. As the comparing operation 608 completes the match against the payee name variations in the lexicon, list build operation 610 builds a list of possible payee name matches and includes the similarity value. The payee name or payee name variation with the highest similarity value is identified, and the payee name or payee name variation with the second highest similarity value is identified. If the answer with the highest similarity value exceeds a first predetermined threshold value, one of the criteria in the payee name verification operation 108 (FIG. 1A) is satisfied. If the difference in similarity values between the answer with the highest value and the answer with the second highest value is greater than a second predetermined threshold then, the second criteria for payee name verification is satisfied. With both criteria satisfied the payee name verification is successful, and the account number and check number identifying the verified check is entered into the positive pay file 115 by store operation 114 (FIG. 1A). If both criteria are not satisfied, the payee name verification is not satisfied, and the account number and check number is entered in the mismatch check file 111 by the mismatch check store operation 110 (FIG. 1A).

It will be apparent to one skilled in the art that other matching criteria and threshold values for success might be used. For example, the threshold for highest value might be used alone for payee name verification without a difference between first answer value and second answer value. In other matching schemes a match of character images character by character might be required to identify a successful match. In another feature of the invention, the payee verification might be further enhanced by retrieving a portion of the address information to validate that the payee name corresponds to a location associated with a payee name. It will be apparent to one skilled in the art that any number of matching techniques might be used to match the payee name against the payee name and the issued check file.

Further, in another embodiment of the invention, the lexicon might be built using all the payee names in the issued check file rather than just the payee name or names from the check having the same account and check number as the scanned check. In another alternative, the issuer of the checks might just furnish a lexicon of payee names that the issuer wishes the bank to use in verifying payee names.

Also, the invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

While the invention has been particularly shown and described with reference to preferred embodiments thereof, it will be understood by those skilled in the art that various other changes in the form and details may be made therein without departing form the spirit and scope of the invention.

What is claimed is:

1. In a computer-implemented bank-check processing system having a scanner for scanning issued checks, a method for verifying a payee name from a scanned check image of a check being processed by the system against a stored payee name received by the system from the issuer of the check, said method comprising:
locating a payee field on the check image;
extracting an image of the payee field at a location found by the act of locating;
parsing the payee field to separate a scanned payee name from other information in the payee field;
matching the scanned payee name separated from the payee field against the stored payee name to verify the payee name.

2. The method of claim 1 wherein said act of locating comprises:
identifying a format for the check image; and
searching for the payee field at a predetermined location on the check image based on the format for the check image.

3. The method of claim 2 wherein the act of matching comprises:
comparing the scanned payee name against payee names in a lexicon of payee names based on stored payee names to verify the scanned payee name if at least some predetermined similarity exists between the scanned payee name and a payee name in the lexicon.

4. The method of claim 3 further comprises:
building the lexicon of payee names based on the stored payee name or names from an issued check file received from the issuer of the check, the lexicon including the payee names and variations on the payee names.

5. The method of claim 3 further comprises:
building the lexicon of payee names based on the stored payee name or names of the check being processed from an issued check file received from the issuer of the check, the lexicon including the payee names and variations on the payee names.

6. A bank check processing system for verifying a payee name on an issued check before disbursing funds to the payee, the system comprising:
an image retrieve module retrieving a scanned check image of the issued check;
a file retrieve module retrieving an issued check file from the issuer of the issued check, the issued check file having a list of check records with each check record including a check identifier and a check payee name;
a payee name verify module, responsive to the scanned check image of the issued check and a check record for the issued check from the issued check file, matching a scanned payee name from the scanned check image of the issued check against a check payee name from the check record of the issued check in order to indicate whether or not the scanned payee name is verified; and
a disburse module, in response to payee name verify module, disbursing funds to the payee if the scanned payee name is the same name as the check payee name.

7. The system of claim 6, wherein each check record further includes a check amount and the system further verifies an amount of funds for the issued check, the system comprises in addition:
an amount verify module, responsive to the scanned check image and the issued check file, matching a scanned amount from the scanned check image of the issued check against a check amount from the check record of the issued check in order to indicate whether or not the scanned amount is verified; and
the disburse module, in response to the amount verify module and in response to the payee name verify module, disbursing finds to the payee if the scanned payee name is verified by the payee name verify module and the scanned amount is verified by the amount verify module.

8. The bank check processing system of claim 6 wherein the verify payee module comprises:
a locate module finding the location of the scanned payee name on the scanned check image and extracting the scanned payee name; and
a match payee name module matching the scanned payee name to a lexicon of check payee names to verify the payee name.

9. The bank check processing system of claim 8 wherein the locate module comprises:
a read module reading a scanned check identifier from the scanned check image and getting a check format based on the check identifier;
an extract module extracting payee field information at a location on the scanned check image based on the check format; and
a parse module parsing the payee field information to separate out the scanned payee name from the payee field information.

10. The bank check processing system of claim 9 further comprises:
a check payee name retrieve module responsive to the scanned check identifier retrieving the check payee name from a check record identified by the scanned check identifier;

11. The bank check processing system of claim 8 further comprises:
a lexicon build module creating the lexicon of payee names, the lexicon including all check payee names in the issued check file and variations of the check payee names.

12. The bank check processing system of claim 8 wherein the lexicon of payee names is received from the issuer of the issued check.

13. Apparatus for positive-pay verifying an issued check in a bank check processing system comprising:
retrieve means for retrieving, based on a bank account number and a check number, a record payee name from an issued check file listing checks issued by a payer of the issued check;
compare means responsive to said retrieve means for comparing a payee name from the issued check against a vocabulary of record payee names, the vocabulary including at least the record payee name and record payee name variations based on the record payee name; and
said compare means for verifying the payee name based on the similarity between the payee name on the issued check and a payee name from the vocabulary of payee names.

14. The apparatus of claim 13 wherein the bank check processing system has a check scanner for issued checks, and the apparatus further comprises:
locate means for locating a payee name field on the scanned image of the issued check and reading from the payee name field the payee name.

15. The apparatus of claim 14 wherein said locate means comprises:
read means for reading a scanned bank account number from a scanned image of the issued check;
format means responsive to the read means for getting the check format of the issued check based on the scanned bank account number;
said locate means locating the payee name field based on the check format.

16. The apparatus of claim 15 and in addition:
said retrieve means for retrieving, based on a bank account number and a check number, a record amount for the issued check;
amount verify means for reading an amount from the scanned image of the issued check and for comparing the amount from the issued check against the record amount for the issued check, and verifying the amount based on the similarity between the amount on the issued check and the record amount.

17. The apparatus of claim 13 wherein the vocabulary includes all record payee names in the issued check file and variations on the payee names in the issued check file.

18. The apparatus of claim 13 wherein the vocabulary includes a list of record payee names for the bank account number.

19. A computer program product readable by a bank computing system and encoding a computer program of instructions for executing a computer process for positive pay verification of issued checks, said computer process comprising:
locating a payee name field on the issued check and parsing a payee name from the payee name field to generate an issued check payee name;
getting from an issued check file, listing checks issued by a payer of the issued check, a record payee name for the issued check; and
reading the issued check payee name by matching the issued check payee name field against a lexicon of payee names based on the record payee name; and verifying the issued check payee name when there is a high confidence match between the issued check payee name and a payee name in the lexicon.

20. The computer program product of claim 20 wherein the computer process further comprises:
getting a record amount for the issued check from the issued check file; and
verifying an amount on the issued check when the amount on the issued check matches the record amount.

21. The computer program product of claim 20 the act of locating in the computer process further comprises:
identifying a check format of the issued check from a bank account number on the issued check; and
locating the payee name field based on the check format.
